(19) United States
(12) Patent Application Publication
(10) Pub. No.: US 2013/0268552 A1
(43) Pub. Date: Oct. 10, 2013

(54) Brokered Exchange of Private Data

(71) Applicants: John C. Platt, Bellevue, WA (US); Surajit Chaudhuri, Redmond, WA (US); Lev Novik, Bellevue, WA (US); Henricus Johannes Maria Meijer, Mercer Island, WA (US); Efim Hudis, Bellevue, WA (US)

(72) Inventors: John C. Platt, Bellevue, WA (US); Surajit Chaudhuri, Redmond, WA (US); Lev Novik, Bellevue, WA (US); Henricus Johannes Maria Meijer, Mercer Island, WA (US); Efim Hudis, Bellevue, WA (US)

(73) Assignee: MICROSOFT CORPORATION, Redmond, WA (US)

(21) Appl. No.: 13/443,573

(22) Filed: Apr. 10, 2012

(51) Int. Cl. G06F 17/30

(52) U.S. Cl. 707/769; 707/781; 707/758; 707/E17.014

(57) ABSTRACT

A data broker observes datasets that are opened or created by a user. The data broker looks for related datasets in a data catalog. If a related dataset is found, the data broker asks the user if they want to access the related dataset. If the user is interested, then the data broker asks the data owner if they are willing to share access to the related dataset with the user. The data owner may deny access, allow access, or request the user's identity. If the user does not want to provide his or her identity, then access to the related dataset is denied. If the user does provide his or her identity, then the data owner determines whether or not to share the data with that user. Once the owner approves sharing the related dataset, then the dataset or a link to the dataset is sent to the user.

### BACKGROUND

Most of the data generated by individuals, enterprises, and government agencies is locked up on the individual users' computer or in data stores that are secured in a manner that prevents access to others. Much of this data, such as personal medical, financial and other information, deserves such access-restriction protection and should be secured from unrestricted access by other individuals. For example, users may not want to share certain personal or confidential data. However, users may be willing to share other data that is stored on their computers.

A tremendous amount of privately held data would be very useful to others, such as co-workers, but this data is not shared with them even though the dataset owner or creator may not have privacy or confidentiality concerns about the data. The main reason that such privately held data is not shared is because it is too cumbersome and time-consuming for most users to carefully categorize all of their data and determine what can be shared with whom. Rather than risk exposing unorganized, incorrect or confidential data, it is easier for users to just keep most or all of their data private.

Existing approaches to share more data among users focus on making it easier to comb through the data and to establish an appropriate security level for each document. However, experience shows that such efforts have not made it easier to share appropriate data among users.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments of a brokered data exchange provide a mechanism that uses an automated software system to determine which datasets may be of interest to other individuals or groups. The owner of a dataset of interest and the potential user of that dataset are engaged in a brokered conversation that does not violate the privacy of either without their consent and that results in the sharing of the dataset with the potential user if both parties agree.

### DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a high level block diagram of a system for providing a brokered exchange of private data according to one embodiment.

FIG. 2 illustrates an interaction between a data broker, a potential data user and a dataset owner according to one embodiment.

FIG. 3 illustrates an entry 300 in the data catalog index according to one embodiment.

FIG. 4 is a flowchart of a method or process for providing a brokered exchange of data.

FIG. 5 illustrates an example of a suitable computing and networking environment to provide a brokered data exchange.

### DETAILED DESCRIPTION

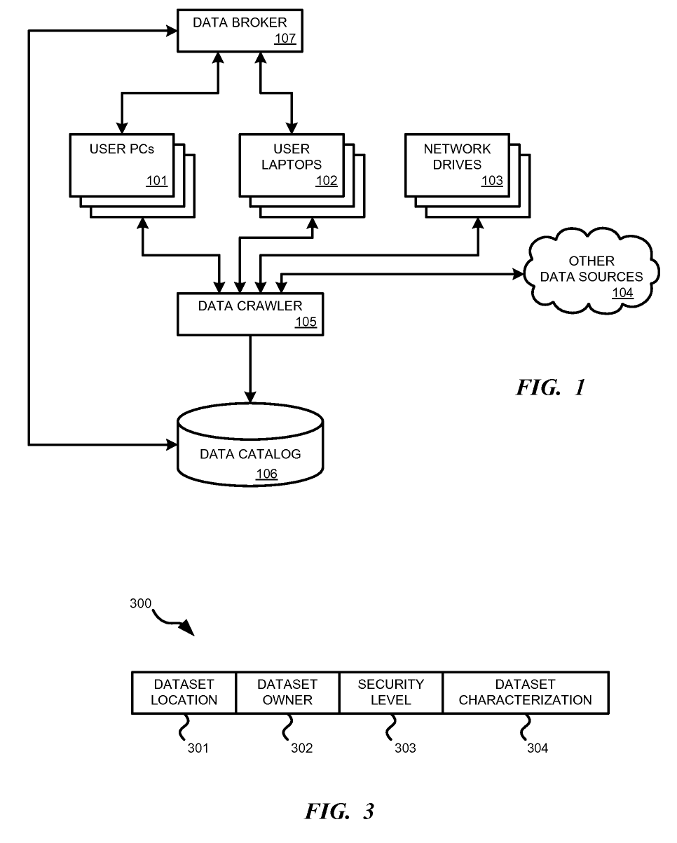

FIG. 1 is a high level block diagram of a system for providing a brokered exchange of private data according to one embodiment. Users generate, modify and store data on personal computers (PC) 101, laptop and notebook computers 102, and network storage devices 103. Additionally, users may generate, modify and store data on numerous other devices 104, such as mobile devices, smartphones, tablet and slate computers, personal digital assistants (PDA), and the like.

Data crawler 105 is a computer system that is capable of crawling and indexing all of the documents and data stored on user PCs 101, user laptops 102, network drives 103, and other data sources 104. In one embodiment, data crawler 105 may be similar to a company-wide backup solution. Data crawler 105 may, on one hand, have access to all of the data of all of the users; however, on the other, data crawler 105 may not trigger privacy concerns because no human will see the data or data index. In some embodiments, such as Internet-based, consumer-facing scenarios, data crawler 105 may be combined with deterministic encryption to further reduce the risk to users' privacy, while preserving the ability to search as many data sources as possible.

Data crawler 105 generates a data catalog 106 that stores one or more indices of the data found on the data sources. The indices may be organized by user, user device, subject matter, and/or collections of user-defined groups, such as co-workers, projects, teams, employees, family members and the like. In one embodiment, data catalog 106 does not store actual data, but only stores the indices of where the data may be found. The system may assume that the indices in data catalog 106 are private and, therefore, does not share those indices directly with any users.

Using the indices in data catalog 106, a data broker 107 provides a recommendation system to users. Whenever a user is working on a task, such as working on a table within a spreadsheet on a user PC 101 or laptop 102, the data broker “sees” the data that the user is working on. For example, a user PC may provide a copy of the spreadsheet or table to data broker 107, or data crawler 105 or data broker 107 may crawl the active spreadsheet to create an index of the user's active data. Data broker 107 compares the data the user is currently using to the data that is indexed in data catalog 106. Such as comparison may be made continuously, periodically or one time, such as when a data file is opened or saved. When data broker 107 evaluates whether the user's active data, such as the spreadsheet table, is related to other known data indexed in data catalog 106. Such a comparison may be made using various levels of specificity. For example, data broker 107 may identify related data that uses the same or a subset of the data types in the user's current data. Alternatively, the data broker 107 may identify matching or similar columns of data or matching data titles or headings between the user's current data and data indexed in data catalog 106. A simple example of identifying such related data is an observation that a newer version of the user's dataset (e.g. spreadsheet or table) is indexed in data catalog 106. When data broker 107 identifies such related data, it generates a recommendation to notify the user that related data may be available.

In an alternate embodiment, users' explicit search requests, separately or in combination with the data that the user is currently working on, may be used to trigger recommendations from the data catalog.

FIG. 2 illustrates an interaction between a data broker, a potential data user and a dataset owner according to one embodiment. User 201 opens a document that includes a dataset, such as a spreadsheet or table, and begins working with data in the document. Data broker 202 observes the dataset that the user is working with and compares it to data catalog 203. If data broker 202 identifies a related dataset that is indexed in data catalog 203, then data broker 202 mediates an exchange of the data between user 201 and dataset owner 204.

If user 201 is working on a spreadsheet, data broker 202 looks for related datasets in data catalog 203 and may identify, for example, a more recent version of the spreadsheet or a data set with similar columns that is stored on dataset owner 204's computer. Data broker 202 cannot simply notify user 201 that the data set exists or that it is located on dataset owner 204's computer without potentially violating both parties' privacy. Instead, in one embodiment, data broker 202 exchanges the following messages with the parties.

Data broker 202 receives message 210 identifying the current dataset that user 201 is working on. Message 210 may be a copy of the dataset, a list of the data types in the dataset, samples of the data, metadata from the dataset, and/or other information about the current dataset. When data broker 202 identifies a related dataset in catalog 203, it sends message 211 notifying user 201 that a related dataset is available. Message 211 may include or trigger a query asking whether the user (1) wants to attempt to gain access to the dataset, or (2) wants the data broker to stop looking for datasets related to this one.

When message 211 is received, user 201 has not been informed who may own the related dataset, but only knows that a related dataset is out in the network somewhere. User 201 may be working on a project or subject matter that is confidential, personal, or otherwise private and, therefore, user 201 may not want to ask for the related dataset in order to prevent others from knowing that he is working on a particular project or subject matter. In that case, user 201 instructs data broker 204 in message 212 to stop looking for and/or asking about related datasets and the process will end. Alternatively, user 201 uses message 212 to request access to the related dataset.

If user 201 requests access, then data broker 202 will send message 213 to the dataset owner notifying them that another party is using a dataset that is related to a dataset that is stored on the dataset owner's computer or that is otherwise owned or controlled by the dataset owner. Message 213 may include or trigger a message asking whether the dataset owner (1) is willing to share this dataset with a co-worker without knowing the co-worker's identity, (2) would like to know who the other party is before making a decision, or (3) is not willing to share this dataset. Dataset owner 204 responds with message 214 indicating one of these options.

If the dataset owner 204 indicates in message 214 that he or she does not want to share the related dataset, then the process ends. If the dataset owner is willing to share the related dataset, then data broker 202 skips to message 219 and provides user 201 with access to the related dataset. Embodiments of the system can use numerous techniques for presenting the related dataset to user 20 which may range from showing the related dataset in context of the original to a link to where the related dataset may be found on the network.

If dataset owner 204 indicates that he or she would like to know who the requestor is, then data broker 202 sends message 215 to user 201 asking whether his or her identity can be provided to the owner of the related dataset. In message 216, user 201 may approve the disclosure of portions of his or her identity, such as the user's full name or the identity of a project, team, or division associated with the user. Alternatively, in message 216, user 201 may reject the related dataset rather than providing an identity. If user 201 does not want to provide his or her identity, then the process ends. Otherwise, data broker provides user 201's identity to dataset owner 204 in message 217. Dataset owner 204 then approves or rejects sharing the related dataset in message 218. If the dataset owner does not approve sharing the dataset with the specific user 201, then the process ends. Otherwise, message 219 provides user 201 with the related dataset or a link to where the related dataset may be found on the network.

In other embodiments, data broker may skip messages 211 and 212 and instead first ask dataset owner whether or not he or she wants to share the related dataset before ever notifying user that a related dataset exists. In this case, user would only know of that there is a related dataset if the dataset owner is willing to share the dataset either outright or after with approval after reviewing the user's identity.

In alternative embodiments, the user's identity or a portion of the user's identity may be shared in the first message to the dataset owner—with the user's permission or knowledge—so that a more informed decision can be quickly made by the dataset owner.

An important aspect of this protocol is that it protects the privacy of both the user and the owner of the data. For example, neither the fact that the dataset owner has inappropriate data, nor the fact that the user is looking at inappropriate data would be revealed without their consent. The protections of the above protocol will enable vast majority of users, particularly in enterprise or corporate environments, to participate in such a system without qualms. This will significantly increase the level of dataset sharing and, therefore, access to relevant information among co-workers and other groups.

In another embodiment, data crawler 105 assigns a security level to the data index that indicates who a dataset can be shared with. For example, the security level may indicate that the dataset should never be shared or, with approval, would only be shared with a particular team, project, or enterprise or might be shared with anyone.

Additional embodiments may provide partial data sharing, which allows users to indicate which part of the datasets are “shareable” and which are not. For example, the user may be willing to share all columns of a customer dataset except for columns or fields with credit card numbers, social security numbers or other sensitive personal or financial information. After the related dataset is identified to the dataset owner, he or she may be provided the option to select which fields of the related dataset are available for sharing. The fields selected by the dataset owner for sharing may vary, for example, depending upon the user's identity.

Further embodiments may provide social attributes of the dataset owners in the data catalog. For example, the data catalog may include a ranking, area of expertise, years of experience, or other social attributes of the dataset owner. These social attributes may be used instead of the dataset owner's real identity. Alternatively, the social attributes may be provided to the user along with the notification of a related dataset. This might be done without requiring the dataset owner's approval so that the user has an idea of the source of the related dataset before asking for access.

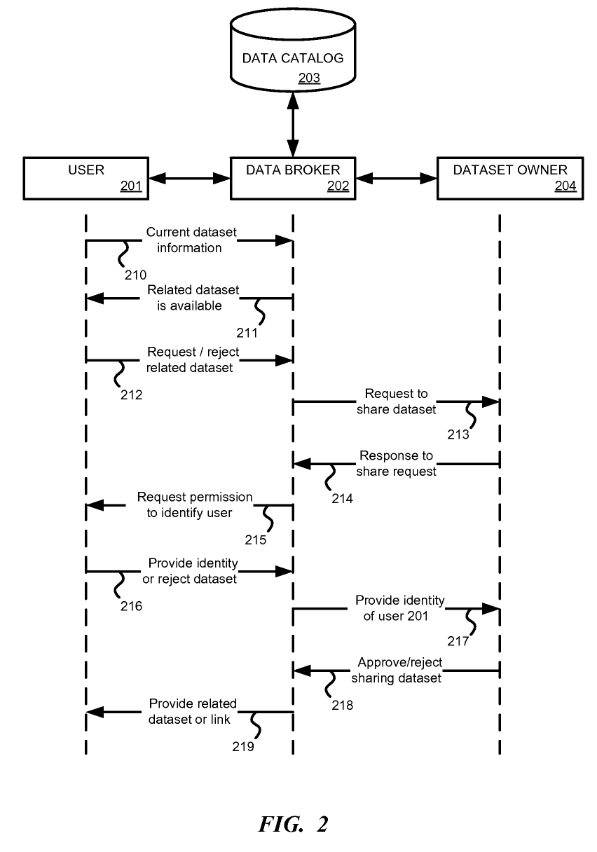

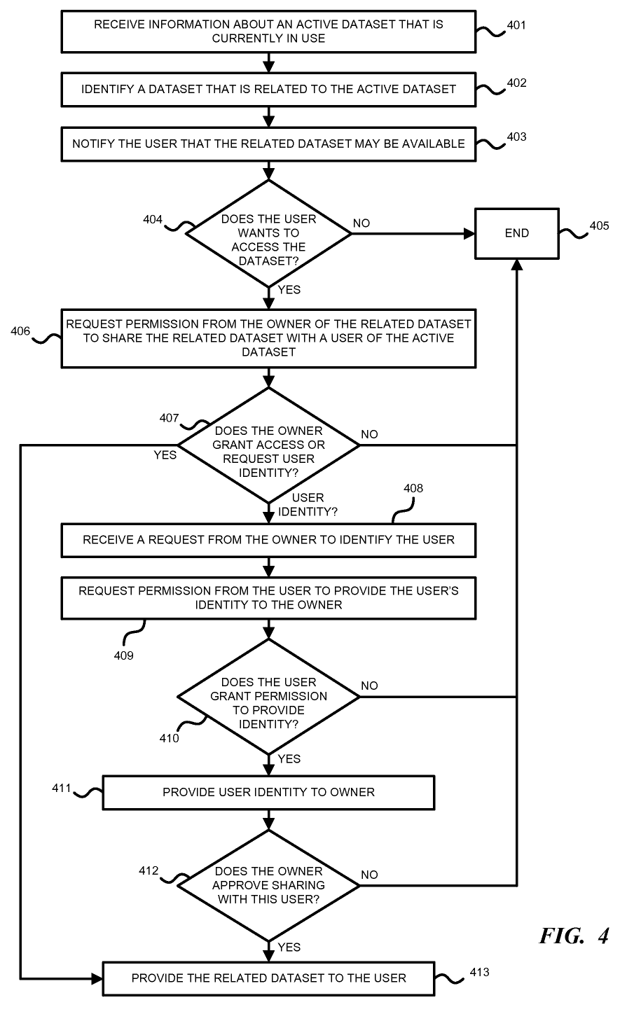

FIG. 3 illustrates an entry 300 in the data catalog index according to one embodiment. For each dataset, the location 301 where the dataset is stored is listed. Dataset location 301 may be a network storage device, a user machine, or any other location. Field 302 identifies the dataset owner, which may be, for example, the original creator of the dataset, the last editor of the dataset, or the person who is responsible for the storage device or machine where the dataset is stored. Field 303 is a security level for the dataset that indicates if the dataset can be shared and/or what parties the dataset may be shared with. Dataset characterization 304 comprises sufficient information about the dataset that allows a data broker to compare datasets and identify related datasets. The most data-intensive version of characterization 304 would be a copy of the cited dataset, which could make the catalog index too large to be of practical use. In other versions, characterization 304 may comprise more practical abstractions of the dataset, such as data types and/or metadata found in the dataset, examples of the data stored in the dataset, and/or vector representations of the dataset.

In one embodiment, the data broker may have a process for dealing with orphan datasets for which the dataset owner is no longer available. For example, the dataset owner may have left a company after creating the dataset, but he or she would still be listed in the data catalog. To provide the highest level of privacy protection, the data broker might not suggest orphan datasets to current users. In other configurations, the data broker may have a list of one or more alternative contacts that are used in place of an unavailable dataset owner. The alternative contacts may be a former supervisor of the dataset owner, a human resources or personnel department representative, or someone acting in an ombudsman or trusted intermediary role for the dataset owner.

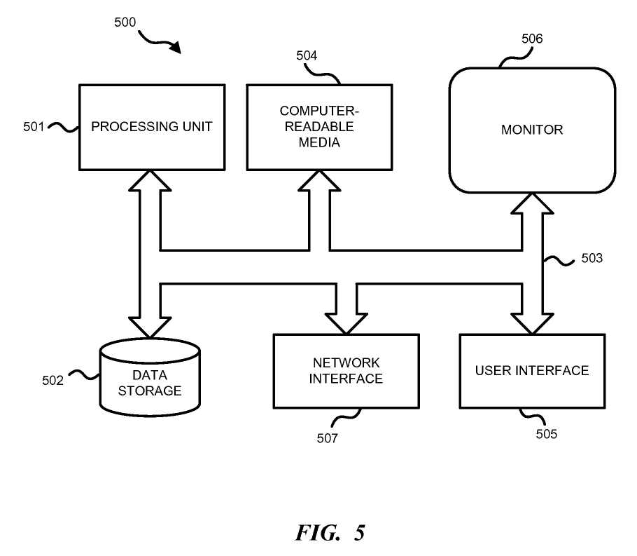

FIG. 4 is a flowchart of a method or process for providing a brokered exchange of data. In step 401, information is received about an active dataset currently in use. As used herein, the term “active dataset” is intended to mean a dataset that a user is currently creating, reviewing, reading, editing, improving, copying, or otherwise manipulating. The active dataset may be represented by a document, table, or spreadsheet open on the user's computer, for example. The information about the active dataset may be received while the user is working with the active dataset or when the user is searching for a dataset to open. The information received about the active dataset may be one or more of a copy of the active dataset, an abstraction of the dataset, metadata from the active dataset, examples of the data stored in the active dataset, and/or a vector representation of the dataset.

In step 402, a dataset that is related to the active dataset identified. The related dataset may be identified, for example, by comparing the information about the active dataset to a data catalog. The related dataset may be identified, for example, because it is a different version of the active dataset, it has metadata that is found in the active dataset, it has data types that are found in the active dataset, and/or it has one or more of the same columns of data as the active dataset. It will be understood that this only a non-exhaustive sample list of related datasets and that the system may use any criteria to identify related datasets.

In step 403, the user is notified that a related dataset may be available. In step 404, the user is asked whether he or she wants to access the related dataset. If the user does not want to access the related dataset, then the process ends at 405.

If the user does want to access the dataset, then the process moves to step 406 and permission is requested from the owner of the related dataset to share the related dataset with a user of the active dataset. The owner's response is evaluated in step 407 to determine whether the owner wants to grant or deny access or to know identify the user. If the owner does not want to grant access to the related dataset, then the process ends at 405.

If the owner wants to grant access to the related dataset without further information, then the related dataset is provided to the user in step 413. If, instead, the owner wants to know who requested access, then the process moves to step 408 where the owner requests to identify the user. In step 409, the user is requested for permission to provide an identity to the owner. The user's response is evaluated at step 410. If the user does not want to provide an identity, then the process ends at 405.

If the user does provide an identity, then that identity is provided to the owner at step 411. If the owner does not approve this user at step 412, then the process ends at 405. If the user does approve sharing the dataset, then the related dataset is provided to the user in step 413. The user may be provided with the related dataset, for example, by delivering a copy of the related dataset to the user or providing the user with a link to a location where the related dataset is stored.

In other embodiments, additional steps may be included to provide the data owner's identity to the user—if requested by the user and permitted by the owner. This would allow the user to know who will find out that he or she is working on the dataset if the user's identity is released. The user may not want to expose his or her identity to some data owners and would instead prefer to not access datasets for those owners.

It will be understood that steps 210-219 of the process illustrated in FIG. 2 and steps 401-413 of the process illustrated in FIG. 4 may be executed simultaneously and/or sequentially. It will be further understood that each step may be performed in any order and may be performed once or repetitiously.

In another embodiment, the data broker may be used to search for datasets that are of interest to the user without having a current dataset open. The user may provide a list of search criteria, such as data types, metadata, or examples of data of interest. The data broker will then look for a highly related dataset that fits these criteria. If the dataset is access restricted, then the data broker can negotiate access for the user in manner described above.

One drawback for the using the system for a search/data-open application (compared to the recommendation-type system described above), is that this would allow the user to evaluate if specific information is available on the network. The user could “fish” for information on the network using this type of system, so the system may include features to discourage such fishing for information.

In one embodiment, intentional false-positive-results may be used. The system may occasionally act as if it has found a dataset that matches the search criteria—whether or not it actually has found such a dataset—and then ask the user if he or she is willing to provide an identity to a (non-existent) data owner. The user would not know that this is a false-positive test and, therefore, would be unlikely to go further with an improper search if his or her name was going to be associated with the search. Instead of providing his or her name, the user is instead likely to quit the search.

In another embodiment, if a dataset if found that matches the search criteria, then the data broker may start with the data owner and ask for their permission to share the dataset before notifying the user that a possible match exists. If the data owner does not want to share the dataset, then the system does not notify the user that there is a possible matching dataset. As a result, the user—who may be fishing for information—never knows if there are matching, but disallowed datasets on the network.

In other embodiments, the datasets may be processed in a distributed computing network or cloud computing environment, such as a set of pooled computing resources delivered over the Internet. The cloud may provide a hosting environment that does not limited an application, such as a data crawler or a data broker, to a specific set of resources. Depending on the platform, applications may scale dynamically and increase their share of resources on-the-fly. For example, in FIG. 1, network drives 103, other data sources 104, and data catalog 106 may be components of a distributed storage devices in a cloud computing environment. Additionally, user PCs 101, user laptops 102, data crawler 105 and data broker 107 may run on one or more virtual machines in the cloud computing environment. These components may also be embodied in a distributed or centralized data center.

FIG. 5 illustrates an example of a suitable computing and networking environment 500 on which the examples of FIGS. 1-4 may be implemented to provide a brokered data exchange. The computing system environment 500 is only one example of a suitable computing environment and is not intended to suggest any limitation as to the scope of use or functionality of the invention. The invention is operational with numerous other general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 5, an exemplary system for implementing various aspects of the invention may include a general purpose computing device in the form of a computer 500. Components may include, but are not limited to, various hardware components, such as processing unit 501, data storage 502, such as a system memory, and system bus 503 that couples various system components including the data storage 502 to the processing unit 501. The system bus 503 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 500 typically includes a variety of computer-readable media 504. Computer-readable media 504 may be any available media that can be accessed by the computer 500 and includes both volatile and nonvolatile media, and removable and non-removable media, but excludes propagated signals. By way of example, and not limitation, computer-readable media 504 may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 500. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media. Computer-readable media may be embodied as a computer program product, such as software stored on computer storage media.

The data storage or system memory 502 includes computer storage media in the form of volatile and/or nonvolatile memory such as read only memory (ROM) and random access memory (RAM). A basic input/output system (BIOS), containing the basic routines that help to transfer information between elements within computer 500, such as during start-up, is typically stored in ROM. RAM typically contains data and/or program modules that are immediately accessible to and/or presently being operated on by processing unit 501. By way of example, and not limitation, data storage 502 holds an operating system, application programs, and other program modules and program data.

Data storage 502 may also include other removable/non-removable, volatile/nonvolatile computer storage media. By way of example only, data storage 502 may be a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The drives and their associated computer storage media, described above and illustrated in FIG. 5, provide storage of computer-readable instructions, data structures, program modules and other data for the computer 500.

A user may enter commands and information through a user interface 505 or other input devices such as a tablet, electronic digitizer, a microphone, keyboard, and/or pointing device, commonly referred to as mouse, trackball or touch pad. Other input devices may include a joystick, game pad, satellite dish, scanner, or the like. Additionally, voice inputs, gesture inputs using hands or fingers, or other natural user interface (NUI) may also be used with the appropriate input devices, such as a microphone, camera, tablet, touch pad, glove, or other sensor. These and other input devices are often connected to the processing unit 501 through a user input interface 505 that is coupled to the system bus 503, but may be connected by other interface and bus structures, such as a parallel port, game port or a universal serial bus (USB). A monitor 506 or other type of display device is also connected to the system bus 503 via an interface, such as a video interface. The monitor 506 may also be integrated with a touch-screen panel or the like. Note that the monitor and/or touch screen panel can be physically coupled to a housing in which the computing device 500 is incorporated, such as in a tablet-type personal computer. In addition, computers such as the computing device 500 may also include other peripheral output devices such as speakers and printer, which may be connected through an output peripheral interface or the like.

The computer 500 may operate in a networked or cloud-computing environment using logical connections 507 to one or more remote devices, such as a remote computer. The remote computer may be a personal computer, a server, a router, a network PC, a peer device or other common network node, and typically includes many or all of the elements described above relative to the computer 500. The logical connections depicted in FIG. 5 include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computer 500 may be connected to a public or private network through a network interface or adapter 507. In some embodiments, a modem or other means for establishing communications over the network. The modem, which may be internal or external, may be connected to the system bus 503 via the network interface 507 or other appropriate mechanism. A wireless networking component such as comprising an interface and antenna may be coupled through a suitable device such as an access point or peer computer to a network. In a networked environment, program modules depicted relative to the computer 500, or portions thereof, may be stored in the remote memory storage device. It may be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A dataset processing system, comprising:
a processor; and
a memory coupled to the processor, the memory configured to store program instructions executable by the processor to cause the communication processing system to:
receive information about an active dataset currently in use;
identify a dataset that is related to the active dataset;
request permission from an owner of the related dataset to share the related dataset with a user of the active dataset; and
upon receiving permission from the owner, provide the user with the related dataset.

2. The dataset processing system of claim 1, wherein receiving information about the active dataset further comprises:
receiving a copy of the active dataset.

3. The dataset processing system of claim 1, wherein receiving information about the active dataset further comprises:
receiving an abstraction of the dataset.

4. The dataset processing system of claim 1, wherein receiving information about the active dataset further comprises one or more of:
receiving examples of the data stored in the active dataset.

5. The dataset processing system of claim 1, wherein
receiving information about the active dataset further comprises:
receiving a vector representation of the dataset.

6. The dataset processing system of claim 1, wherein the related dataset is selected from the group consisting of:
a different version of the active dataset;
a dataset with data types that are found in the active dataset; and
a dataset with one or more of the same columns of data as the active dataset.

7. The dataset processing system of claim 1, further comprising:
notify the user that the related dataset may be available; and
before requesting permission from the owner, query whether the user wants to access the related dataset.

8. The dataset processing system of claim 1, further comprising:
receive a request from the owner to identify the user; and
request the user's permission to provide a portion of an identity to the owner.

9. The dataset processing system of claim 1, further comprising:
provide a portion of an owner identity to the user; and
request the user's permission to provide an identity to the owner.

10. The dataset processing system of claim 1, wherein providing the user with the related dataset further comprises:
provide the user with a copy of the related dataset.

11. The dataset processing system of claim 1, wherein providing the user with the related dataset further comprises:
providing the user with a link to a location where the related dataset is stored.

12. A method, comprising:
performing, by a processor in a computer system,
receiving information about a current dataset being accessed by a user;
notifying the user that a related dataset is available;
receiving a user request for the related dataset;
sending a request to a dataset owner to share the related dataset;
receiving a request for the user's identity from the dataset owner;
requesting permission from the user to provide an identity;
providing the user's identify to the dataset owner; and
receiving approval from the dataset owner to share the related dataset with the user.

13. The method of claim 12, further comprising:
providing a link to a storage location for the related dataset to the user.

14. The method of claim 12, further comprising:
providing a copy of the related dataset to the user.

15. The method of claim 12, further comprising:
searching a data catalog using the information about a current dataset to identify one or more related datasets.

16. The method of claim 12, wherein the information about a current dataset being accessed by a user is provided when the user is searching for datasets.

17. The method of claim 12, wherein the information about a current dataset being accessed by a user is provided when the user saves the current dataset.

18. A computer-readable storage device storing computer-executable instructions that when executed by at least one processor cause the at least one processor to perform a method for brokering the exchange of data, the method comprising:
receive information about an active dataset;
identify a dataset that is related to the active dataset;
notify a user that the related dataset may be available;
query whether the user wants to access the related dataset;
request permission from an owner of the related dataset to share the related dataset with a user of the active dataset; and
upon receiving permission from the owner, providing the user with the related dataset.

19. The computer-readable storage device of claim 18, wherein the related dataset is identified by comparing the information about the active dataset to a data catalog index.

20. The computer-readable storage device of claim 18, the method for brokering the exchange of data further comprising:
providing the user's identity to the dataset owner; and
providing the dataset owner's identity to the user.
